(19) United States
(12) Patent Application Publication
(10) Pub. No.: US 2022/0372223 A1
(43) Pub. Date: Nov. 24, 2022

(54) POLYIMIDE, VARNISH, AND FILM

(71) Applicant: ENEOS Corporation, Tokyo (JP)

(72) Inventors: Masatoshi HASEGAWA, Chiba (JP); Junichi ISHII, Chiba (JP); Daisuke WATANABE, Tokyo (JP)

(73) Assignee: ENEOS Corporation, Tokyo (JP)

(21) Appl. No.: 17/640,484

(22) PCT Filed: Sep. 9, 2020
(86) PCT No.: PCT/JP2020/034172

§ 371 Date: Mar. 4, 2022

(30) Foreign Application Priority Data
Sep. 10, 2019 (JP) 2019-164892

(51) Int. Cl. C08G 73/10; C08J 5/18; C09D 179/08

(52) U.S. Cl. CPC C08G 73/105; C08J 5/18; C09D 179/08; C08G 73/1007; C08J 2379/08

(57) ABSTRACT

Provided is a polyimide having a repeating unit represented by the following Formula (1):

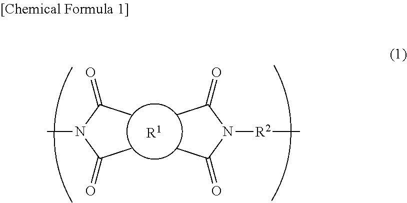

wherein R¹ represents a tetravalent group; R² represents a divalent group;
provided that at least one of R¹'s is represented by the following Formula (2); and among R²'s, at least one group is represented by the following Formula (3), and at least one other group is represented by the following Formula (4):

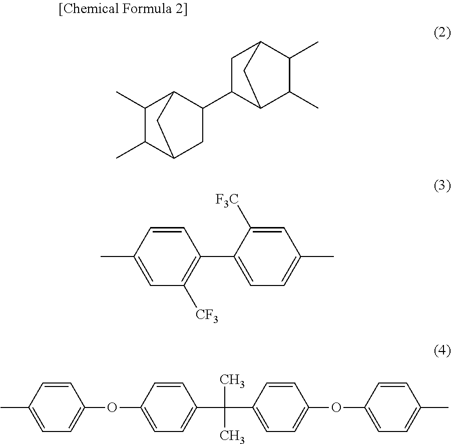

### TECHNICAL FIELD

The present invention relates to a polyimide, and a varnish and a film containing the polyimide.

### BACKGROUND ART

In recent years, glass substrates have been used in various flat panel displays (FPD) such as liquid crystal displays; however, since weight reduction has become an important issue along with thickness reduction of FPDs, development of transparent plastic substrates as an alternative material for glass substrates is in progress. For example, in Patent Literature 1, a polyether sulfone composition including a specific structural unit is described.

### CITATION LIST

### Patent Literature

Patent Literature 1: Japanese Unexamined Patent Publication No. 2012-197449

### SUMMARY OF INVENTION

### Technical Problem

However, regarding conventional transparent plastics, it was difficult to achieve both transparency and heat resistance. Furthermore, it is desirable, from the viewpoint of processability into a film and the like, that transparent plastics have solubility in solvents and can be handled in a solution state (varnish); however, there is also a problem that what is easily dissolved in a solvent often has low heat resistance.

It is an object of the present invention to provide a polyimide having excellent heat resistance and having excellent solvent solubility. Furthermore, it is another object of the present invention to provide a varnish containing the above-described polyimide, and a film including the above-described polyimide.

### Solution to Problem

The inventors of the present invention conducted a thorough investigation in order to solve the above-described problems, and as a result, the inventors found that a polyimide having a specific repeating unit can achieve both excellent heat resistance and dimensional stability and the handleability in a solution state, thus completing the present invention.

That is, the present invention relates to the following.

[1] A polyimide having a repeating unit represented by the following Formula (1):

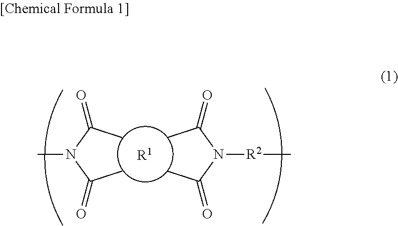

wherein R¹ represents a tetravalent group; R² represents a divalent group,

provided that at least one of R¹'s is represented by the following Formula (2); and among R²'s, at least one group is represented by the following Formula (3), and at least one other group is represented by the following Formula (4):

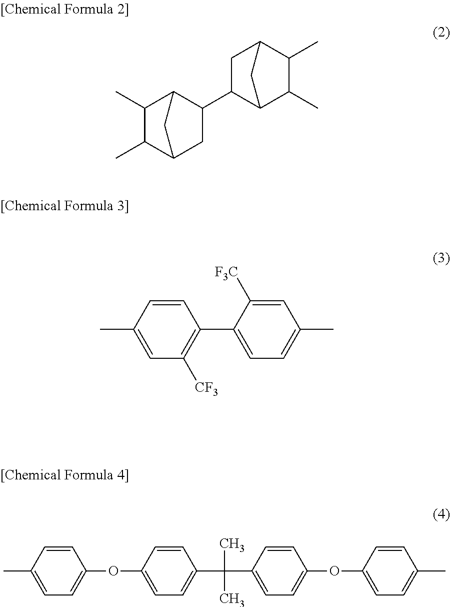

[2] The polyimide according to [1], wherein the proportion occupied by the groups represented by Formula (3) in R² in the polyimide is 20 mol % to 90 mol %.

[3] The polyimide according to [1] or [2], wherein the proportion occupied by the groups represented by Formula (4) in R² in the polyimide is 10 mol % to 80 mol %.

[4] The polyimide according to any one of [1] to [3], wherein the proportion occupied by the groups represented by Formula (2) in R¹ in the polyimide is 60 mol % or more.

[5] A varnish containing the polyimide according to any one of [1] to [4] and a solvent.

[6] A film containing the polyimide according to any one of [1] to [4].

### Advantageous Effects of Invention

According to the present invention, a polyimide having excellent heat resistance and dimensional stability and having excellent handleability in a solution state is provided. Furthermore, according to the present invention, a varnish containing the polyimide, and a film including the polyimide are provided.

### BRIEF DESCRIPTION OF DRAWINGS

FIG. 1 is a diagram showing the infrared absorption spectrum of a polyimide thin film of Example 1.

### DESCRIPTION OF EMBODIMENTS

Hereinafter, suitable embodiments of the present invention will be described in detail.

<Polyimide>

The polyimide of the present embodiment is a polyimide having a repeating unit represented by the following Formula (1):

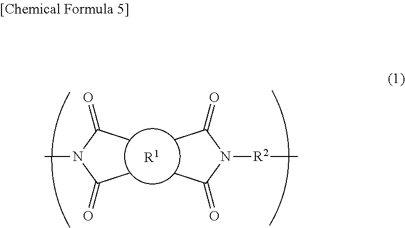

In the formula, R¹ represents a tetravalent group, and R² represents a divalent group. However, at least one of R¹'s is represented by the following Formula (2). Furthermore, among R²'s, at least one group is represented by the following Formula (3), and at least one other group is represented by the following Formula (4):

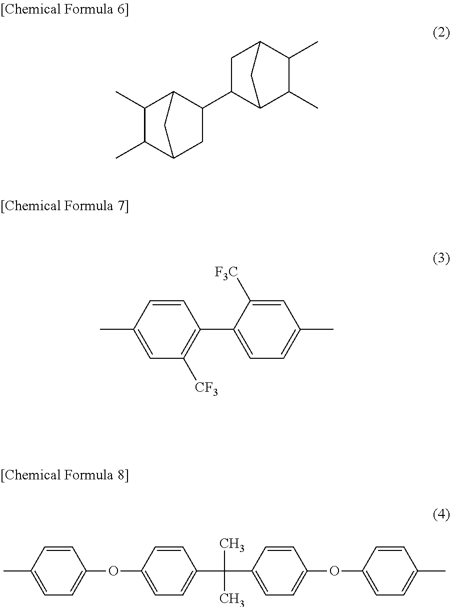

The polyimide of the present embodiment acquires excellent transparency, excellent heat resistance (high T_{g}), excellent dimensional stability (low thermal expansion characteristics), and excellent handleability in a solution state, due to the repeating unit represented by Formula (1).

The reason why such an effect is obtained is not necessarily clearly known; however, the reason is considered as follows. It is considered that the polyimide of the present embodiment exhibits excellent transparency, excellent heat resistance, and excellent dimensional stability due to a rigid imide structure based on an alicyclic group represented by Formula (2) and a fluorine-containing group represented by Formula (3). Furthermore, it is considered that since a flexible bent structure is introduced into the polyimide of the present embodiment by means of the ether-containing group represented by Formula (4), the polyimide main chain is bent to lower the intermolecular force, and high solubility in solvents is obtained. Meanwhile, usually, when a bent structure is introduced into the polyimide main chain, it is expected that the dimensional stability at the time of heating is deteriorated. However, in the present embodiment, solubility and film toughness are enhanced while excellent transparency, excellent heat resistance, and excellent dimensional stability are maintained, by introducing a specific structure represented by Formula (4) as a bent structure.

The polyimide of the present embodiment is composed of a repeating unit constituting the main chain and terminal parts. The proportion occupied by the repeating unit represented by Formula (1) in the total amount of repeating units carried by the polyimide of the present embodiment may be, for example, 70% by mass or more, and the proportion is preferably 80% by mass or more, more preferably 90% by mass or more, even more preferably 99% by mass or more, and may be 100% by mass.

The terminal part of the polyimide of the present embodiment is not particularly limited and may be similar to the terminal parts of known polyimides. For example, the terminal part may be an acid anhydride group, an amino group, or the like. The terminal parts present at both ends of the main chain of the polyimide may be identical with or different from each other.

The repeating unit represented by Formula (1) may be, for example, a repeating unit form by a polyaddition reaction between a tetracarboxylic acid dianhydride and a diamine and an imidization reaction subsequent thereto. That is, R¹ in Formula (1) can be said to be a remaining group obtained by removing two dicarboxylic acid anhydride groups from a tetracarboxylic acid dianhydride (that is, a tetracarboxylic acid dianhydride residue), and R² in Formula (1) can be said to be a remaining group obtained by removing two amino groups from a diamine (that is, a diamine residue).

According to the present embodiment, at least one of a plurality of R^{t}'s is represented by Formula (2). The group represented by Formula (2) can be said to be a residue of bisnorbornanetetracarboxylic dianhydride (hereinafter, also referred to as “BNBDA”).

The proportion occupied by the group represented by Formula (2) in R¹ in the polyimide of the present embodiment may be, for example, 60 mol % or more, and the proportion is preferably 70 mol % or more, more preferably 80 mol % or more, and may be 100 mol %.

When R¹ is a group other than the group represented by Formula (2), R¹ may be a group derived from a tetracarboxylic acid dianhydride other than BNBDA (a remaining group obtained by removing two dicarboxylic acid anhydride groups from a tetracarboxylic acid dianhydride).

Examples of the tetracarboxylic acid dianhydride other than BNBDA include an aliphatic tetracarboxylic acid dianhydride and an aromatic tetracarboxylic acid dianhydride. Examples of the aliphatic tetracarboxylic acid dianhydride include bicyclo[2.2.2]oct-7-ene-2,3,5,6-tetracarboxylic dianhydride, bicyclo[2.2.2]octane-2,3,5,6-tetracarboxylic dianhydride, tetrahydrofuran-2,3,4,5-tetracarboxylic dianhydride, bicyclo-3,3′,4,4′-tetracarboxylic dianhydride, 1,2,4,5-cyclohexanetetracarboxylic dianhydride, 1,2,3,4-cyclobutanetetracarboxylic dianhydride, and 1,2,3,4-cyclopentanetetracarboxylic dianhydride. Furthermore, examples of the aromatic tetracarboxylic acid dianhydride include pyromellitic dianhydride, 3,3′,4,4′-biphenyltetracarboxylic dianhydride, 3,3′,4,4′-benzophenonetetracarboxylic dianhydride, 3,3′,4,4′-biphenyl ether tetracarboxylic dianhydride, 3,3′,4,4′-biphenylsulfone tetracarboxylic dianhydride, 2,2′-bis(3,4-dicarboxyphenyl)propanoic dianhydride, hydroquinone bis(trimellitate anhydride), 1,4,5,8-naphthalenetetracarboxylic dianhydride, and 2,3,6,7-naphthalenetetracarboxylic dianhydride.

According to the present embodiment, at least one of a plurality of R²'s is represented by Formula (3), and at least one other group is represented by Formula (4). That is, the polyimide of the present embodiment has both the group represented by Formula (3) and the group represented by Formula (4) as R² in Formula (1). The group represented by Formula (3) can also be said to be a residue of 2,2′-bis(trifluoromethyl)benzidine (hereinafter, also referred to as “TFMB”). Furthermore, the group represented by Formula (4) can also be said to be a residue of 2,2-bis[4-(4-aminophenoxy)phenyl]propane (hereinafter, also referred to as “BAPP”).

The proportion occupied by the group represented by Formula (3) in R² in the polyimide of the present embodiment may be, for example, 20 mol % or more, and the proportion is preferably 30 mol % or more, more preferably 40 mol % or more, and even more preferably 45 mol % or more. When the proportion of the groups represented by Formula (3) is increased, the dimensional stability tends to be more satisfactory. Furthermore, the proportion occupied by the groups represented by Formula (3) in R² in the polyimide of the present embodiment may be, for example, 95 mol % or less, and the proportion is preferably 90 mol % or less, and more preferably 85 mol % or less. When the proportion of the groups represented by Formula (3) is decreased, the solvent solubility, transparency, film toughness, and optical isotropy tend to be more satisfactory. That is, the proportion occupied by the groups represented by Formula (3) in R² in the polyimide of the present embodiment may be, for example, 20 mol % to 95 mol %, 20 mol % to 90 mol %, 20 mol % to 85 mol %, 30 mol % to 95 mol %, 30 mol % to 90 mol %, 30 mol % to 85 mol %, 40 mol % to 95 mol %, 40 mol % to 90 mol %, 40 mol % to 85 mol %, 45 mol % to 95 mol %, 45 mol % to 90 mol %, or 45 mol % to 85 mol %.

The proportion occupied by the groups represented by Formula (4) in R² in the polyimide of the present embodiment may be, for example, 5 mol % or more, and the proportion is preferably 10 mol % or more, and more preferably 15 mol % or more. When the proportion of the groups represented by Formula (4) is increased, the solvent solubility, transparency, film toughness, and low birefringence tend to be more satisfactory. Furthermore, the proportion occupied by the groups represented by Formula (4) in R² in the polyimide of the present embodiment may be, for example, 80 mol % or less, and the proportion is preferably 70 mol % or less, more preferably 60 mol % or less, and even more preferably 55 mol % or less. When the proportion of the groups represented by Formula (4) is decreased, the dimensional stability tends to be more satisfactory. That is, the proportion occupied by the groups represented by Formula (4) in R² in the polyimide of the present embodiment may be 5 mol % to 80 mol %, 5 mol % to 70 mol %, 5 mol % to 60 mol %, 5 mol % to 55 mol %, 10 mol % to 80 mol %, 10 mol % to 70 mol %, 10 mol % to 60 mol %, 10 mol % to 55 mol %, 15 mol % to 80 mol %, 15 mol % to 70 mol %, 15 mol % to 60 mol %, or 15 mol % to 55 mol %.

The sum occupied by the groups represented by Formula (3) and the groups represented by Formula (4) in R² in the polyimide of the present embodiment may be, for example, 70 mol % or more, and the sum is preferably 80 mol % or more, more preferably 90 mol % or more, and may be 100 mol %.

When R² is a group other than the groups represented by Formula (3) and Formula (4), R² may be a group derived from a diamine other than TFMB and BAPP (a remaining group obtained by removing two amino groups from a diamine).

Examples of the diamine other than TFMB and BAPP include an aliphatic diamine and an aromatic diamine. Examples of the aliphatic diamine include 4,4′-methylenebis(cyclohexylamine), 4,4′-methylenebis(3-methylcyclohexylamine), 4,4′-methylenebis(3-ethylcyclohexylamine), 4,4′-methylenebis(3,5-dimethylcyclohexylamine), 4,4′-methylenebis(3,5-diethylcyclohexylamine), isophoronediamine, trans-1,4-cyclohexanediamine, cis-1,4-cyclohexanediamine, 1,4-cyclohexanebis(methylamine), 2,5-bis(aminomethyl)bicyclo[2.2.1]heptane, 2,6-bis(aminomethyl)bicyclo[2.2.1]heptane, 3,8-bis(aminomethyl)tricyclo[5.2.1.0]decane, 1,3-diaminoadamantane, 2,2-bis(4-aminocyclohexyl)propane, 2,2-bis(4-aminocyclohexyl)hexafluoropropane, 1,3-propanediamine, 1,4-tetramethylenediamine, 1,5-pentamethylenediamine, 1,6-hexamethylenediamine, 1,7-heptamethylenediamine, 1,8-octamethylenediamine, and 1,9-nonamethylenediamine. Examples of the aromatic diamine include p-phenylenediamine, m-phenylenediamine, 2,4-diaminotoluene, 2,5-diaminotoluene, 2,4-diaminoxylene, 2,4-diaminodurene, 4,4′-methylenedianiline, 4,4′-methylenebis(3-methylaniline), 4,4′-methylenebis(3-ethylaniline), 4,4′-methylenebis(2-methylaniline), 4,4′-methylenebis(2-ethylaniline), 4,4′-methylenebis(3,5-dimethylaniline), 4,4′-methylenebis(3,5-diethylaniline), 4,4′-methylenebis(2,6-dimethylaniline), 4,4′-methylenebis(2,6-diethylaniline), 4,4′-oxydianiline, 3,4′-oxydianiline, 3,3′-oxydianiline, 2,4′-oxydianiline, 2,2′-oxydianiline, 4,4′-diaminodiphenylsulfone, 3,3′-diaminodiphenylsulfone, 4,4′-diaminobenzophenone, 3,3′-diaminobenzophenone, 4,4′-diaminobenzanilide, benzidine, 3,3′-dihydroxybenzidine, 3,3′-dimethoxybenzidine, o-toluidine, m-toluidine, 1,4-bis(4-aminophenoxy)benzene, 1,4-bis(3-aminophenoxy)benzene, 1,3-bis(4-aminophenoxy)benzene, 1,3-bis(3-aminophenoxy)benzene, 4,4′-bis(4-aminophenoxy)biphenyl, bis(4-(3-aminophenoxy)phenyl)sulfone, bis(4-(4-aminophenoxy)phenyl)sulfone, 2,2-bis(4-(4-aminophenoxy)phenyl)propane, 2,2-bis(4-(4-aminophenoxy)phenyl)hexafluoropropane, 2,2-bis(4-aminophenyl)hexafluoropropane, and p-terphenylenediamine.

The weight average molecular weight (Mw) of the polyimide of the present embodiment is not particularly limited and may be, for example, 5.00×10⁴ or more, and the weight average molecular weight is preferably 1.0×10⁵ or more, and more preferably 1.5×10⁵ or more. When the weight average molecular weight is large, for example, the thermal and mechanical physical properties tend to be satisfactory. The upper limit of the weight average molecular weight (Mw) of the polyimide is not particularly limited, and the weight average molecular weight (Mw) of the polyimide may be, for example, 4.0×10⁵ or less. That is, the weight average molecular weight (Mw) of the polyimide of the present embodiment may be, for example, 5.00×10⁴ to 4.0×10⁵, 1.0×10⁵ to 4.0×10⁵, or 1.5×10⁵ to 4.0×10⁵. Incidentally, the weight average molecular weight (Mw) is measured by the method described in the Examples that will be described below.

The intrinsic viscosity of the polyimide of the present embodiment may be, for example, 1.0 dL/g or more, and the intrinsic viscosity is preferably 2.0 dL/g or more, and more preferably 3.0 dL/g or more. It can be said that such a polyimide has a higher molecular weight. The upper limit of the intrinsic viscosity of the polyimide is not particularly limited, and the intrinsic viscosity of the polyimide may be, for example, 5.0 dL/g or less. That is, the intrinsic viscosity of the polyimide of the present embodiment may be, for example, 1.0 to 5.0 dL/g, 2.0 to 5.0 dL/g, or 3.0 to 5.0 dL/g. Incidentally, the intrinsic viscosity of the polyimide is measured by the method described in the Examples that will be described below.

With regard to the polyimide of the present embodiment, the glass transition temperature (T_{g}) is preferably 250° C. or higher, and more preferably 300° C. or higher. It can be said that such a polyimide has higher heat resistance. The upper limit of the glass transition temperature (T_{g}) of the polyimide is not particularly limited, and the glass transition temperature (T_{g}) of the polyimide may be, for example, 400° C. or lower. That is, the glass transition temperature (T_{g}) of the polyimide may be, for example, 250° C. to 400° C. or 300° C. to 400° C. Incidentally, the glass transition temperature (T) is measured by the method described in the Examples that will be described below.

With regard to the polyimide of the present embodiment, the 5% weight reduction temperature (T_{d}⁵) in a nitrogen atmosphere is preferably 450° C. or higher, and more preferably 480° C. or higher. It can be said that such a polyimide has higher heat resistance. Incidentally, the 5% weight reduction temperature (T_{d}⁵) is measured by the method described in the Examples that will be described below.

<Varnish>

The varnish of the present embodiment is a polyimide solution containing the above-mentioned polyimide and a solvent. The solvent in the varnish is not particularly limited as long as it is a solvent capable of dissolving the polyimide. Examples of the solvent include N,N-dimethylformamide, N,N-dimethylacetamide, N-methyl-2-pyrrolidone (NMP), dimethyl sulfoxide, and γ-butyrolactone.

By applying and drying the varnish of the present embodiment, a film containing the above-mentioned polyimide (polyimide film) can be easily obtained.

The concentration of the polyimide in the varnish of the present embodiment may be appropriately changed according to the thickness of the film, the method of applying the varnish, and the like, and the concentration is, for example, 5% to 30% by mass, and preferably 10% to 20% by mass.

The varnish of the present embodiment may be produced by dissolving the polyimide in a solvent or may be produced by synthesizing the polyimide in a solvent.

The varnish of the present embodiment may further contain other components in addition to the polyimide, to the extent that does not impair the required characteristics of the varnish. Examples of the other components include an inorganic filler, an adhesion promoter, a peeling agent, a flame retardance, an ultraviolet stabilizer, a surfactant, a leveling agent, an antifoaming agent, a fluorescent brightening agent, a crosslinking agent, a polymerization initiator, and a photosensitizer, and the contents of these are not particularly limited.

<Film>

The film of the present embodiment is a film containing the above-mentioned polyimide (hereinafter, also referred to as polyimide film). The film of the present embodiment can be easily produced by, for example, applying and drying the above-mentioned varnish.

The film of the present embodiment may further contain other components in addition to the polyimide, to the extent that does not impair the required characteristics of the film. Examples of the other components include an inorganic filler, an adhesion promoter, a peeling agent, a flame retardant, an ultraviolet stabilizer, a surfactant, a leveling agent, an antifoaming agent, a fluorescent brightening agent, a crosslinking agent, a polymerization initiator, and a photosensitizer, and the contents of these are not particularly limited.

The thickness of the film of the present embodiment may be appropriately changed according to the use application of the film or the like, and the thickness may be, for example, 10 to 100 μm and is preferably 15 to 30 μm.

With regard to the film of the present embodiment, it is preferable that the mean coefficient of linear thermal expansion in the temperature range of 100° C. to 200° C. per thickness of 20 μm is 35 ppm/K or less. It can be said that such a film has superior dimensional stability. Incidentally, the mean coefficient of linear thermal expansion is measured by the method described in the Examples that will be described below.

With regard to the film of the present embodiment, it is preferable that the birefringence in the thickness direction is 0.06 or less. It can be said that such a film has superior low birefringence. Incidentally, the birefringence in the thickness direction is measured by the method described in the Examples that will be described below.

When the film of the present embodiment has a thickness of about 20 μm, it is preferable that the total light transmittance is 85% or higher. It can be said that such a film has superior transparency. Incidentally, the total light transmittance is measured by the method described in the Examples that will be described below.

When the film of the present embodiment has a thickness of about 20 μm, it is preferable that the light transmittance to light having a wavelength of 400 nm is 80% or higher. It can be said that such a film has superior transparency. Incidentally, the light transmittance to light having a wavelength of 400 nm is measured by the method described in the Examples that will be described below.

When the film of the present embodiment has a thickness of about 20 μm, it is preferable that the yellowness index (YI value) is 5.0 or less. It can be said that such a film has superior transparency. Incidentally, the yellowness index is measured by the method described in the Examples that will be described below.

When the film of the present embodiment has a thickness of about 20 μm, it is preferable that the turbidity (haze) is 5.0 or less. It can be said that such a film has superior transparency. Incidentally, the turbidity (haze) is measured by the method described in the Examples that will be described below.

When the film of the present embodiment has a thickness of about 20 μm, it is preferable that the tensile modulus is 3.0 GPa or higher. It can be said that such a film is a film having superior toughness. Incidentally, the tensile modulus is measured by the method described in the Examples that will be described below.

When the film of the present embodiment has a thickness of about 20 μm, it is preferable that the breaking strength is 100 MPa or higher. It can be said that such a film is a film having superior toughness. Incidentally, the breaking strength is measured by the method described in the Examples that will be described below.

The film of the present embodiment may be used, for example, alone, or may be used as a laminated body with various base materials.

<Method for Producing Polyimide>

The polyimide of the present embodiment can be produced by, for example, imidizing a polyamic acid formed by a polyaddition reaction between a tetracarboxylic acid dianhydride and a diamine. In the present embodiment, the polyaddition reaction and the imidization may be carried out separately, or the imidization may be carried out simultaneously with the polyaddition reaction, or subsequently to the polyaddition reaction in the same solution.

The tetracarboxylic acid dianhydride includes a compound represented by the following Formula (2′) (bisnorbornanetetracarboxylic dianhydride, BNBDA).

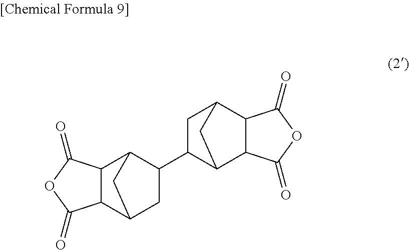 [SMILES: O=C1OC(=O)C2C3CC(CC3C3CC4CC3C3C(=O)OC(=O)C43)C12]

The amount of BNBDA may be, for example, 60 mol % or more based on the total amount of the tetracarboxylic acid dianhydride, and the amount is preferably 70 mol % or more, more preferably 80 mol % or more, and may be 100 mol %.

The tetracarboxylic acid dianhydride may further include a compound other than BNBDA. Examples of the tetracarboxylic acid dianhydride other than BNBDA include the above-mentioned aliphatic tetracarboxylic acid dianhydrides and aromatic tetracarboxylic acid dianhydrides.

The diamine includes a compound represented by the following Formula (3′) (2,2′-bis(trifluoromethyl)benzidine, TFMB) and a compound represented by the following Formula (4′) (2,2-bis[4-(4-aminophenoxy)phenyl]propane, BAPP).

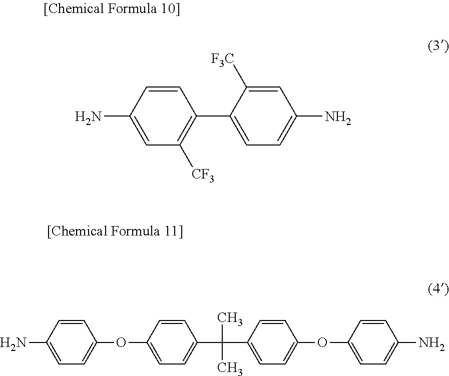 [SMILES: Nc1ccc(-c2ccc(N)cc2C(F)(F)F)c(C(F)(F)F)c1 ; CC(C)(c1ccc(Oc2ccc(N)cc2)cc1)c1ccc(Oc2ccc(N)cc2)cc1]

The amount of TFMB may be, for example, 30 mol % or more based on the total amount of the diamine, and the amount is preferably 40 mol % or more, and more preferably 45 mol % or more. Furthermore, the amount of TFMB may be, for example, 95 mol % or less based on the total amount of the diamine, and the amount is preferably 90 mol % or less, and more preferably 85 mol % or less. That is, the amount of TFMB may be, for example, 30 mol % to 95 mol %, 30 mol % to 90 mol %, 30 mol % to 85 mol %, 40 mol % to 95 mol %, 40 mol % to 90 mol %, 40 mol % to 85 mol %, 45 mol % to 95 mol %, 45 mol % to 90 mol %, or 45 mol % to 85 mol %, based on the total amount of the diamine.

The amount of BAPP may be, for example, 5 mol % or more based on the total amount of the diamine, and the amount is preferably 10 mol % or more, and more preferably 15 mol % or more. Furthermore, the amount of BAP may be, for example, 70 mol % or less based on the total amount of the diamine, and the amount is preferably 60 mol % or less, and more preferably 55 mol % or less. That is, the amount of BAPP may be, for example, 5 mol % to 70 mol %, 5 mol % to 60 mol %, 5 mol % to 55 mol %, 10 mol % to 70 mol %, 10 mol % to 60 mol %, 10 mol % to 55 mol %, 15 mol % to 70 mol %, 15 mol % to 60 mol %, or 15 mol % to 55 mol %, based on the total amount of the diamine.

The total amount of TFMB and BAPP may be, for example, 70 mol % or more based on the total amount of the diamine, and the total amount is preferably 80 mol % or more, more preferably 90 mol % or more, and may be 100 mol %.

The diamine may further include a compound other than TFMB and BAPP. Examples of the diamine other than TFMB and BAPP include the above-mentioned aliphatic diamines and aromatic diamines.

Since the polyimide according to the present embodiment has excellent solvent solubility, the polyimide can be produced in a single stage by heating a tetracarboxylic acid dianhydride and a diamine in a solvent to react, without stopping the reaction in the stage of polyamic acid. At this time, the reaction temperature may be, for example, 150° C. to 250° C. and is preferably 170° C. to 200° C. Furthermore, as the solvent, for example, N,N-dimethylformamide, N,N-dimethylacetamide, N-methyl-2-pyrrolidone (NMP), dimethyl sulfoxide, and γ-butyrolactone can be suitably used.

Thus, suitable embodiments of the present invention have been described; however, the present invention is not intended to be limited to the above-described embodiments.

For example, an aspect of the present invention relates to a polyimide powder obtained by powderizing the above-mentioned polyimide. A polyimide powder has excellent solubility in solvents, and the above-mentioned varnish can be easily prepared by dissolving the polyimide powder in a solvent. Furthermore, a polyimide molded body can also be produced by heating and compressing the polyimide powder.

### EXAMPLES

Hereinafter, the present invention will be described in more detail by way of Examples; however, the present invention is not intended to limit these Examples. Incidentally, the physical property values were measured by the following methods.

<Intrinsic Viscosity>

A polyimide powder was dissolved in N,N-dimethylacetamide (DMAc) to obtain a 0.5 mass % DMAc solution, and the reducing viscosity (η_{red}) was measured at 30° C. using an Ostwald viscometer. This value can be substantially regarded as intrinsic viscosity, and as this value is higher, it is implied that the molecular weight is larger.

<Gel Permeation Chromatography>

The polystyrene-equivalent number average molecular weight (Mn), weight average molecular weight (Mw), and polydispersity (Mw/Mn) of the polyimide were measured by gel permeation chromatography (Jasco, LC-2000 Plus HPLC system) using tetrahydrofuran as an elution solvent and using a GPC column (Shodex, KF-806L) and an ultraviolet-visible light detector (detection wavelength: 300 nm, Jasco, UV-2075) at an elution rate of 1 mL/min.

<Glass Transition Temperature (T_{g})>

The glass transition temperature (T_{g}) of a polyimide film (film thickness about 20 μm) was determined by dynamic viscoelasticity measurement using a thermomechanical analyzer (TMA4000) manufactured by Netzsch Japan K.K., from the peak temperature of a loss energy curve at a frequency of 0.1 Hz and a rate of temperature increase of 5° C./min. A higher Tg implies that the physical heat resistance is higher.

<Coefficient of Linear Thermal Expansion (CTE)>

The CTE of a polyimide film (film thickness about 20 μm) was determined, as an average value in the range of 100° C. to 200° C., by a thermomechanical analysis using a thermomechanical analyzer (TMA4000) manufactured by Netzsch Japan K.K., from the elongation of a specimen under a load of 0.5 g/film thickness of 1 μm and a rate of temperature increase of 5° C./min. As this value is lower, it is implied that the thermal dimensional stability is superior.

<Birefringence (Δnₜₕ)>

The refractive indices in a direction (nᵢₙ) parallel to the polyimide film plane and a direction (nₒᵤₜ) perpendicular to the polyimide film plane were respectively measured using an Abbe refractometer (ABBE 4T, sodium lamp, wavelength 589 nm) manufactured by Atago Co., Ltd., and the birefringence in the film thickness direction of the polyimide film was determined from the relationship of Δnₜₕ=nᵢₙ−nₒᵤₜ. As this value is higher, it is implied that the degree to which polymer chains are oriented parallel to the film plane is higher.

5% Weight Reduction Temperature (T_{d}⁵)>

The temperature at the time when the initial weight of a polyimide film (film thickness about 20 μm) was reduced by 5% in a process of increasing temperature at a rate of temperature increase of 10° C./min, was measured in a nitrogen atmosphere by using a thermogravimetric analyzer (TG-DTA2000) manufactured by Netzsch Japan K.K. A higher value of T_{d}⁵ implies that thermal stability is higher.

<Transparency of Polyimide Film: Light Transmittance at Wavelength of 400 nm, Yellowness Index, Total Light Transmittance, Haze>

Transparency of a polyimide film was evaluated from the following optical characteristics. A light transmittance curve of a polyimide film (film thickness about 20 μm) was measured in a wavelength range of 200 to 800 nm using an ultraviolet-visible light spectrophotometer (V-530) manufactured by JASCO Corp., and the light transmittance at a wavelength of 400 nm was determined. Furthermore, on the basis of this spectrum, the yellowness index (YI value) was determined based on the ASTM E313 standard using a color calculation program manufactured by JASCO Corp. Furthermore, the total light transmittance (Tt) and turbidity (haze) were determined based on the JIS K7361-1 and JIS K7136 standards using a haze meter (NDH4000) manufactured by Nippon Denshoku Industries Co., Ltd.

<Mechanical Characteristics (Tensile Modulus, Breaking Strength, Elongation at Break)>

A polyimide test specimen (3 mm×30 mm×film thickness about 20 μm) was subjected to a tensile test (stretching speed: 8 mm/min) using a tensile testing machine (TENSILON UTM-2) manufactured by A&D Co., Ltd., and the tensile modulus (E) was determined from the initial gradient of a stress-strain curve, the breaking strength (σ_{b}) was determined from the stress at the time of breaking, while the elongation at break (ε_{b}) was determined from the elongation at the time of breaking of the film. Higher elongation at break means higher toughness of the film.

### [Example 1] (BNBDA/TFMB (50); BAPP (50) Copolymer) The Value within the Parentheses Represents Mol %

Into a separable three-neck flask equipped with a nitrogen inlet tube, a stirring device, and a condenser with a Dean-Stark trap, 0.4800 g (1.5 mmol) of TFMB, 0.6158 g (1.5 mmol) of BAPP, and 0.7351 g (6 mmol) of benzoic acid were introduced, 1.8 mL of sufficiently dehydrated γ-butyrolactone (GBL) was added thereto, the mixture was heated to 100° C. to dissolve, subsequently 0.6885 g (6 mmol) of 1-ethylpiperidine and 0.9910 g (3 mmol) of BNBDA were added thereto to react for 4 hours at 200° C. in a nitrogen atmosphere, and a uniform viscous polyimide varnish was obtained. The polymerization reaction was carried out while appropriately adding GBL in order to secure uniform stirring, and a uniform varnish having a solid content concentration of 12.6% by mass was obtained. The intrinsic viscosity of the obtained polyimide was 3.84 dL/g. An isolated polyimide powder was dissolved in deuterated dimethyl sulfoxide, subsequently the ¹H-NMR spectrum was measured, and it was confirmed that the chemical imidization reaction was completed. Furthermore, measurement by gel permeation chromatography was performed, and as a result, the number average molecular weight of the polyimide was 4.31×10⁴, while the weight average molecular weight was 1.59×10⁵.

The polyimide varnish after polymerization was appropriately diluted with GBL and then was slowly added dropwise into a large amount of methanol to precipitate the polyimide, and this was filtered and vacuum-dried at 100° C. for 12 hours to obtain a white fibrous powder was obtained. This was dissolved in deuterated dimethyl sulfoxide, the ¹H-NMR spectrum was measured, and it was confirmed that the chemical imidization reaction was completed. Furthermore, the intrinsic viscosity of the polyimide was 3.84 dL/g. Measurement by gel permeation chromatography was performed, and as a result, the number average molecular weight of the polyimide was 4.31×10⁴, while the weight average molecular weight was 1.59×10⁵.

The polyimide powder isolated as described above was dissolved in GBL to obtain a uniform varnish having a solid content concentration of 7.9% by mass. This was applied on a glass substrate, dried at 65° C. for 3 hours in a hot air dryer, and then dried for 30 minutes at 150° C. and for 1 hour at 200° C. in a vacuum. Next, a film was peeled off from the substrate and was subjected to a heat treatment at 250° C. for 1 hour in a vacuum, and a flexible polyimide film having a film thickness of about 20 μm was obtained.

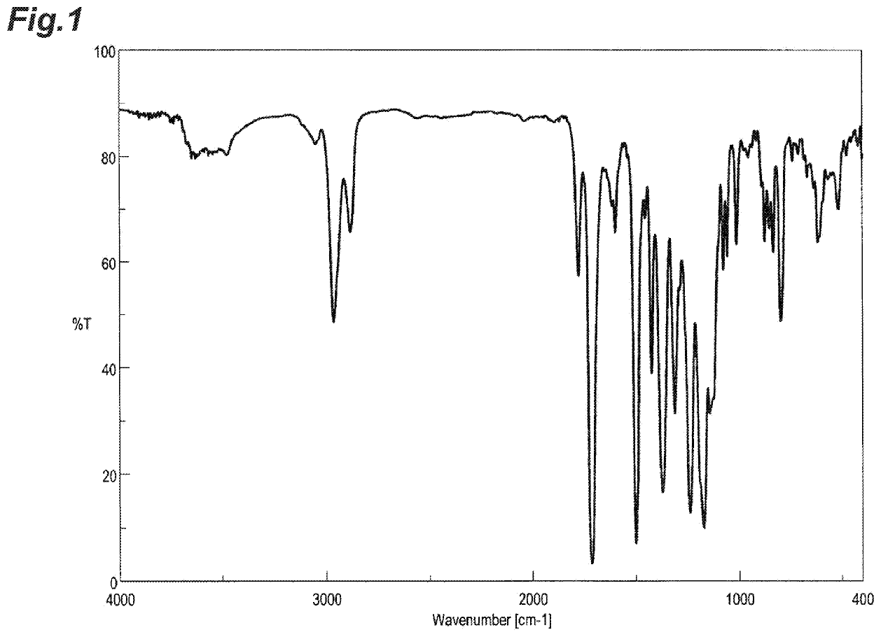

The physical properties of the obtained polyimide film were evaluated, the Tg was 319° C., and the polyimide film exhibited high heat resistance. Furthermore, the coefficient of linear thermal expansion was 30.4 ppm/K, and the polyimide film exhibited relatively low birefringence (0.046) in the thickness direction while having low thermal expansion characteristics. Furthermore, the 5% weight reduction temperature (Td5) was 484° C. in nitrogen. The total light transmittance was 89.5%, the light transmittance at a wavelength of 400 nm was 85.2%, the yellowness index was 2.1, the haze was 1.68%, and the polyimide film had excellent transparency. Furthermore, the mechanical characteristics of this polyimide film were evaluated, the tensile modulus was 3.39 GPa, the breaking strength was 117 MPa, the elongation at break was 34.2% (average value)/58.3% (maximum value), and the polyimide film had high toughness. The evaluation results for the film physical properties are summarized in Table 1. Furthermore, the infrared absorption spectrum of a polyimide thin film is shown in FIG. 1.

### [Example 2] (BNBDA/TFMB (70); BAPP (30) Copolymer)

Polymerization, film formation, and evaluation of the film physical properties were carried out similarly to the methods described in Example 1, except that the molar ratio of the diamine was changed to 70 mol % of TFMB and 30 mol % of BAPP. The physical property values are shown in Table 1. This polyimide film had low thermal expansion characteristics with a CTE of 28.0 ppm/K. For other characteristics as well, the polyimide film maintained satisfactory characteristics similarly to the polyimide of Example 1.

### [Comparative Example 1] (BNBDA/TFMB Homopolyimide)

One-pot polymerization was carried out according to the method described in Example 1 from TFMB and an equimolar amount of BNBDA without using BAPP for the diamine, and since a precipitate was precipitated, and the reaction solution became non-uniform, it was difficult to obtain a uniform polyimide film by subjecting this reaction solution to casting film formation.

TABLE 1

| | η_{red} | | | | | | | | | | ε_{b} | T_{d}⁵ |
|---|---|---|---|---|---|---|---|---|---|---|---|---|
| | (dL g⁻¹) | T₄₀₀ | Tₜₒₜ | | Haze | | T_{g} | CTE | E | _{σb} | av/max | (N₂) |
| | PI | (%) | (%) | YI | (%) | Δnₜₕ | (° C.) | (ppm K⁻¹) | (GPa) | (MPa) | (%) | (° C.) |
| Example 1 | 3.84 | 85.2 | 89.5 | 2.1 | 1.68 | 0.046 | 319 | 30.4 | 3.39 | 117 | 34.2/58.3 | 484 |
| Example 2 | 3.18 | 83.1 | 89.4 | 2.9 | 1.35 | 0.058 | 317 | 28.0 | 4.09 | 119 | 19.2/45.2 | 487 |

1. A polyimide having a repeating unit represented by the following Formula (1): 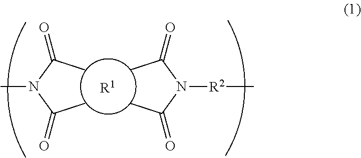
wherein R¹ represents a tetravalent group; R² represents a divalent group,
provided that at least one of R¹'s is represented by the following Formula (2); and among R²'s, at least one group is represented by the following Formula (3), and at least one other group is represented by the following Formula (4):

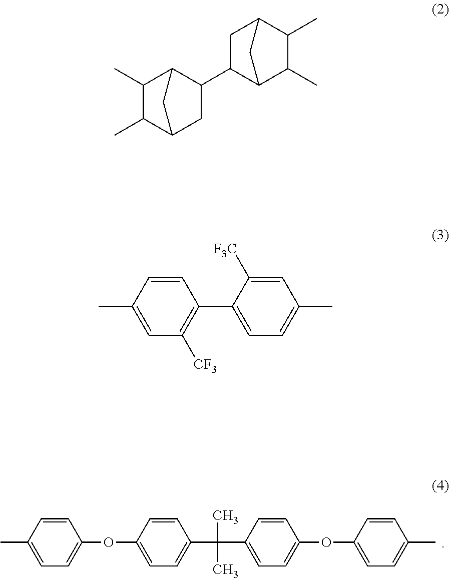

2. The polyimide according to claim 1, wherein the proportion occupied by the groups represented by Formula (3) in R² in the polyimide is 20 mol % to 90 mol %.

3. The polyimide according to claim 1, wherein the proportion occupied by the groups represented by Formula (4) in R² in the polyimide is 10 mol % to 80 mol %.

4. The polyimide according to claim 1, wherein the proportion occupied by the groups represented by Formula (2) in R¹ in the polyimide is 60 mol % or more.

5. A varnish comprising the polyimide according to claim 1 and a solvent.

6. A film comprising the polyimide according to claim 1.
